(19) United States
(12) Patent Application Publication
(10) Pub. No.: US 2025/0243891 A1
(43) Pub. Date: Jul. 31, 2025

(54) QUICK-RELEASE SCREW CONNECTION

(71) Applicant: Ulrich GmbH & Co. KG, Ulm (DE)

(72) Inventors: Stefan MIDDERHOFF, Ulm (DE); Martin SCHROETER, Weissenhorn (DE); Albert SPLEISS, Schlemmerhofen (DE); Jan Niklas ROTHER, Laupheim (DE)

(73) Assignee: Ulrich GmbH & Co. KG, Ulm (DE)

(21) Appl. No.: 19/040,015

(22) Filed: Jan. 29, 2025

(30) Foreign Application Priority Data
Jan. 30, 2024 (DE) 10 2024 102 585.9

(51) Int. Cl. F16B 37/08

(52) U.S. Cl. CPC F16B 37/0814; F16B 37/0857

(57) ABSTRACT

A quick-release screw connection has a threaded bolt having an external thread and has a nut part having an internal thread. The nut part has a threaded piece in which the internal thread is formed, wherein a through-hole, the diameter of which is larger than the outer diameter of the internal thread and smaller than the outer diameter of the threaded piece, is passed through the threaded piece rotated by an angle relative to a longitudinal axis of the internal thread.

### CROSS REFERENCE TO RELATED APPLICATIONS

Applicant claims priority under 35 U.S.C. § 119 of German Application No. 10 2024 102 585.9 filed Jan. 30, 2024, the disclosure of which is incorporated by reference.

### BACKGROUND OF THE INVENTION

### 1. Field of the Invention

The invention relates to a quick-release screw connection with a threaded bolt having an external thread and with a nut part having an internal thread, wherein the nut part has a threaded piece in which the internal thread is formed, and wherein a through-hole, the diameter of which is larger than the external diameter of the internal thread and smaller than the external diameter of the threaded piece, is passed through the threaded piece rotated by an angle relative to a longitudinal axis of the internal thread.

### 2. Description of the Related Art

Threaded connections or screw connections between two components with a thread are widely used solutions for adjusting and fixing two objects relative to each other. The distance S covered when adjusting the two components results from the pitch P of the thread and the number of turns U to S=P×U.

A large number of revolutions are required for long distances or small inclines, which increases the time and effort required. This is particularly disadvantageous in time-sensitive applications, such as in medicine, especially during operations, as increased time expenditure is associated with increased strain on the patient.

Solutions are known from the state of the art that enable large distances to be bridged more quickly. DE 198 25 132 A1 discloses a screw connection with a threaded rod having a bolt thread and a nut. The threaded rod is designed as a square threaded rod with flat surfaces, so that the bolt thread is only formed on thread segments. The nut has a square opening at an acute angle to the nut thread, which interrupts the nut thread in its corner areas in order to allow or prevent the nut from moving relative to the threaded rod, depending on the rotational position. A quick-release screw connection is known from DE 10 2017 129 644 A1, in which a threaded rod with an external thread and a nut are present. Both the external thread and the nut thread are flattened on at least two opposite longitudinal sides. The nut is further divided into a first and second nut piece, whereby the first and second nut piece can be twisted and braced against each other via an external/internal thread pairing.

### SUMMARY OF THE INVENTION

It is the object of the present invention to provide a quick-release screw connection that is easy to operate and enables rapid translational adjustment to bridge the desired distance while maintaining high reliability of the screw connection when the thread is engaged.

This object is solved by a quick-release screw connection with the features of the invention. Advantageous embodiments with expedient further embodiments of the invention are given below.

The quick-release screw connection according to the invention offers the functionality of a threaded connection and also creates the possibility of exposing the threaded connection by tilting the threaded piece, covering large distances quickly by means of a purely translational movement and then re-establishing the threaded connection and securing the position achieved by tilting it again in the opposite direction. Fine adjustment of the axial position of the threaded piece on the threaded bolt can then be achieved again by turning the threaded piece relative to the threaded bolt. The insertion of the through-hole with the selected orientation determined by the angle and the specifically selected diameter ensures that the threads are completely drilled out on one side of the threaded piece, namely on the side towards which the through-hole is inclined, and that a sufficient material thickness of the threaded piece remains, while the threads with sufficient thread depth remain on the opposite side.

The angle comes from an interval of 2° to 45° and preferably from an interval of 5° to 35° and further preferably from an interval of 10° to 25°.

It is particularly preferable if the nut part has a pressure piece that can be adjusted radially to the longitudinal axis between an engagement position that secures the internal thread in engagement with the external thread and an adjustment position that disengages the internal thread from the external thread. The presence of the pressure piece increases the process reliability and the reliability of the quick-release screw connection, as a force must be exerted orthogonally to the adjustment direction in order to enable quick adjustment.

The pressure piece can be acted upon by a return spring, which moves the pressure piece into the engagement position, i.e. the basic state is a given thread engagement and a force must be actively exerted to end the threaded connection. When the force is removed, the threaded connection is re-established under positive control. The spring can also be formed by a leaf spring in particular, although compression springs, tension springs or spiral springs are also suitable in principle.

For this purpose, the pressure piece can have a first guiding surface that acts on the threaded piece in the engaged position. The pressure piece can also have a second guiding surface that acts on the threaded piece in the adjustment position. This design simplifies operation and further increases process reliability, which is also enhanced if the threaded piece has a third guide surface on the side facing the pressure piece, which is inclined to the longitudinal axis from the outside to the inside and is intended for contact with the first guide surface and the second guide surface.

To avoid wedging or tilting, the first guiding surface and the second guiding surface can be rounded on the side facing the longitudinal axis.

Furthermore, it is particularly preferred if the nut part has an annular external part that comprises the threaded bolts and has two opposing side flaps on which the pressure piece is mounted. The external part reliably holds the nut part together because the threaded piece and the pressure piece are permanently held together.

For this purpose, a first guide pin can be formed on each of the side flaps, on which the pressure piece is guided in a slot hole running tangentially to the longitudinal axis, which provides axial securing and at the same time ensures radial guidance.

Furthermore, a cross drilling can pass through the threaded piece perpendicular to the longitudinal axis of the internal thread, with which the threaded piece is mounted on radially inward-facing second guide pins. This improves the control of the tilting movement of the threaded piece relative to the longitudinal axis and improves the cohesion of the nut part.

The features and combinations of features mentioned above in the description as well as the features and combinations of features mentioned below in the figure description and/or shown alone in the figure can be used not only in the combination indicated in each case, but also in other combinations or on their own, without leaving the frame of the invention. Thus, embodiments which are not explicitly shown or explained in the figure, but which emerge from the explained embodiments and can be produced by separate combinations of features, are also to be regarded as comprised by the invention and disclosed.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings,

FIG. 1 is a perspective view of the quick-release screw connection between a threaded bolt and a nut part,

FIG. 2 is a longitudinal section through a threaded piece of the nut part,

FIG. 3 is a longitudinal section through the threaded bolt and the nut part, with the threaded piece in the engagement position in engagement in the thread of the threaded bolt, and

FIG. 4 is a representation corresponding to FIG. 3 with the threaded piece in the adjustment position out of engagement with the thread of the threaded bolt.

### DETAILED DESCRIPTION OF PREFERRED EMBODIMENTS

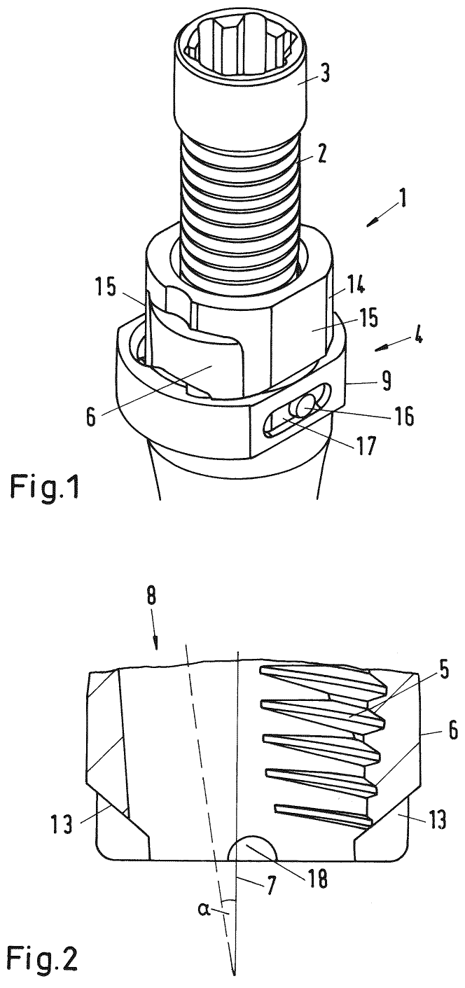

FIG. 1 shows a quick-release screw connection 1, which is formed from a threaded bolt 3 with an external thread 2 and a nut part 4, which has an internal thread 5. The nut part 4 has a threaded piece 6 in which the internal thread 5 is formed. FIG. 2 also shows that a through-hole 8 is passed through the threaded piece 6, rotated by an angle 2 relative to a longitudinal axis 7 of the internal thread 5. The diameter of the through-hole 8 is specifically selected, namely larger than the outer diameter of the internal thread 5 and smaller than the outer diameter of the threaded piece 6, so that the internal thread 5 is drilled out on the one side towards which the through-hole 8 is inclined and the internal thread 5 remains at a sufficient thread depth on the opposite side. The angle α comes from an interval of 2° to 45° and preferably from an interval of 5° to 35° and further preferably from an interval of 10° to 25°.

FIGS. 1, 3 and 4 show that the nut part 4 also has a pressure piece 9 that can be adjusted radially to the longitudinal axis 7 between an engagement position that secures the internal thread 5 in engagement with the external thread 2 and an adjustment position that disengages the internal thread 5 from the external thread 2. For this purpose, the pressure piece 9 is acted upon by a return spring 10, which moves the pressure piece 9 into the engagement position and thus secures it.

The pressure piece 9 has a first guiding surface 11, which acts on the threaded piece 6 in the engagement position, and a second guiding surface 12, which acts on the threaded piece 6 in the adjustment position. Furthermore, on the side facing the pressure piece 9, the threaded piece 6 has a third guiding surface 13 inclined to the longitudinal axis 7 from the outside to the inside and intended for contact with the first guiding surface 11 and the second guiding surface 12.

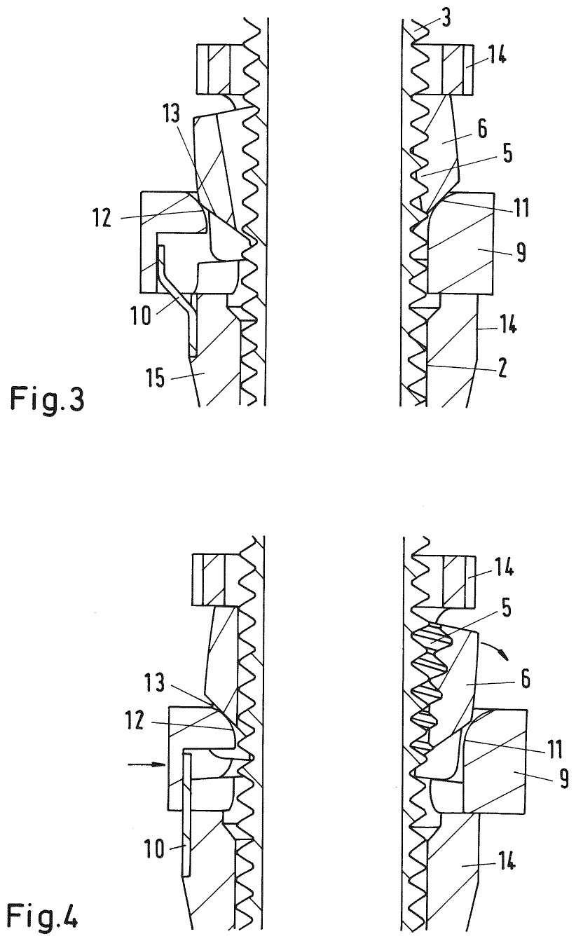

FIGS. 3 and 4 in particular show that the first guiding surface 11 and the second guiding surface 12 are rounded on the side facing the longitudinal axis.

The nut part 4 also has an annular external part 14, which comprises the threaded bolt 3 and has two opposing side flaps 15, on which the pressure piece 9 is mounted. The nut part 4 is thus formed in three parts with the external part 14, the threaded piece 6 and the pressure piece 9. The cohesion of the three parts is achieved by a first guide pin 16 being formed on each of the side flaps 15, on which the pressure piece 9 is axially secured and radially guided in a slot hole 17 extending tangentially to the longitudinal axis 7 and, furthermore, a cross drilling 18 perpendicular to the longitudinal axis 7 of the internal thread 5 passes through the threaded piece 6, with which the threaded piece 6 is mounted on radially inwardly pointing second guide pins.

If the threaded bolts 3 are screwed downwards in the configuration shown in FIG. 3, a reaction force is created that points upwards and is transmitted to the external part 14 via the positive fit. This means that the threaded connection cannot be loosened in this application. Furthermore, however, an axial force can also be exerted downwards on the threaded bolt 3, so that the threaded piece 6 is driven downwards, thereby achieving the configuration shown in FIG. 4, which enables quick adjustment. If, on the other hand, an axial upward force is exerted on the threaded bolt 3, the position of the threaded piece 6 is maintained and secured via the toothing engagement and upward ratcheting of the threaded bolt 3 in the configuration shown in FIG. 3 is blocked

The configuration shown in FIG. 4 can also be achieved by radially adjusting the pressure piece 9 against the force of the return spring 10, whereby the configuration shown in FIG. 3 is automatically restored after the return spring 10 is released.

Although only a few embodiments of the present invention have been shown and described, it is to be understood that many changes and modifications may be made thereunto without departing from the spirit and scope of the invention.

### REFERENCE LIST

1 quick-release screw connection
2 external thread
3 threaded bolts
4 nut part
5 internal thread
6 threaded piece
7 longitudinal axis
8 through-hole
9 pressure piece
10 return spring
11 first guiding surface
12 second guiding surface
13 third guiding surface
14 external part
15 side flaps
16 first guide pin
17 slot hole
18 cross drilling
α angle

What is claimed is:

1. A quick-release screw connection (1) with a threaded bolt (3) having an external thread (2) and with a nut part (4) having an internal thread (5), wherein the nut part has a threaded piece (6) in which the internal thread (5) is formed, and in that a through-hole (8), the diameter of which is larger than the outside diameter of the internal thread (5) and smaller than the outside diameter of the threaded piece (6), is passed through the threaded piece (6) rotated by an angle (α) relative to a longitudinal axis (7) of the internal thread (5).

2. The quick-release screw connection (1) according to claim 1, wherein the angle (α) comes from an interval of 2° to 45° and preferably from an interval of 5° to 35 and further preferably from an interval of 10° to 25°.

3. The quick-release screw connection (1) according to claim 1, wherein the nut part (4) has a pressure piece (9) which can be adjusted radially to the longitudinal axis (7) between an engagement position securing the internal thread (5) in engagement with the external thread (2) and an adjustment position releasing the internal thread (5) from the external thread (2).

4. The quick-release screw connection (1) according to claim 3, wherein the pressure piece (9) is acted upon by a return spring (10) which moves the pressure piece (9) into the engagement position.

5. The quick-release screw connection (1) according to claim 3, wherein the pressure piece (9) has a first guiding surface (11) which acts on the threaded piece (6) in the engagement position.

6. The quick-release screw connection (1) according to claim 3, wherein the pressure piece (9) has a second guiding surface (12) which acts on the threaded piece (6) in the adjustment position.

7. The quick-release screw connection (1) according to claim 6, wherein the threaded piece (6) has, on the side facing the pressure piece (9), a third guiding surface (13) which runs inclined to the longitudinal axis (7) from the outside to the inside and is intended for bearing against the first guiding surface (11) and the second guiding surface (12).

8. The quick-release screw connection (1) according to claim 7, wherein the first guiding surface (11) and the second guiding surface (12) are rounded on the side facing the longitudinal axis (7).

9. The quick-release screw connection (1) according to claim 3, wherein the nut part (4) has an annular external part (14) which comprises the threaded bolt (3) and has two mutually opposite side flaps (15) on which the pressure piece (9) is mounted.

10. The quick-release screw connection (1) according to claim 9, wherein a first guide pin (16) is formed on each of the side flaps (15), on which the pressure piece (9) is axially secured and radially guided in a slot hole (17) extending tangentially to the longitudinal axis (7).

11. The quick-release screw connection (1) according to claim 9, wherein a cross drilling (18) perpendicular to the longitudinal axis (7) of the internal thread (5) passes through the threaded piece (6), by means of which the threaded piece (6) is mounted on radially inwardly pointing second guide pins.
